(19) United States
(12) Patent Application Publication
(10) Pub. No.: US 2014/0353968 A1
(43) Pub. Date: Dec. 4, 2014

(54) POSITIONING MECHANISM AND EXPANSION ASSEMBLY THEREOF

(71) Applicants: Fu Tai Hua Industry (ShenZhen) Co., Ltd., Shenzhen (CN); HON HAI PRECISION INDUSTRY CO., LTD., New Taipei (TW)

(72) Inventors: JIE LI, Shenzhen (CN); HUI WANG, Shenzhen (CN); HUI-SHENG JI, Shenzhen (CN); SHAN-YAN XIA, Shenzhen (CN); XIAO-BING XU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/288,400

(22) Filed: May 28, 2014

(30) Foreign Application Priority Data
May 31, 2013 (CN) 2013102120944

(51) Int. Cl. F16L 21/035

(52) U.S. Cl. CPC F16L 21/035
USPC 285/374

(57) ABSTRACT

An expansion assembly includes a connecting plug, a deformable sealing sleeve, and an expansion sleeve. The connecting plug defines a through hole configured for air flow to pass therethrough. The deformable sealing sleeve is sleeved on the connecting plug. The expansion sleeve houses the deformable sealing sleeve and is sleeved on the connecting plug. The expansion sleeve comprises a number of resilient arms separated from each other. When airflow is introduced into the deformable sealing sleeve via the connecting plug, the deformable sealing sleeve is expanded, causing the number of resilient arms of the expansion sleeve to expand outward. A positioning mechanism employing the expansion assembly is also disclosed.

### FIELD

The present disclosure generally relates to a positioning mechanism and an expansion assembly thereof.

### BACKGROUND

A positioning mechanism is usually employed to position a workpiece on a worktable for machining or inspecting the workpiece. The positioning mechanism can be a pin.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an embodiment of a positioning mechanism, the positioning mechanism including an expansion assembly.

FIG. 2 is an exploded, isometric view of the positioning mechanism of FIG. 1.

FIG. 3 is a cross-sectional view of the positioning mechanism of FIG. 1, taken along line III-III.

FIG. 4 is a cross-sectional view of the positioning mechanism of FIG. 1, taken along line IV-IV.

FIG. 5 is a sectional view of the expansion assembly of FIG. 1 in use.

FIG. 6 is an enlarged view of circled portion VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.” The term “coupled” is defined as coupled, whether directly or indirectly through intervening components, and is not necessarily limited to physical connections. The connection can be such that the objects are permanently coupled or releasably coupled.

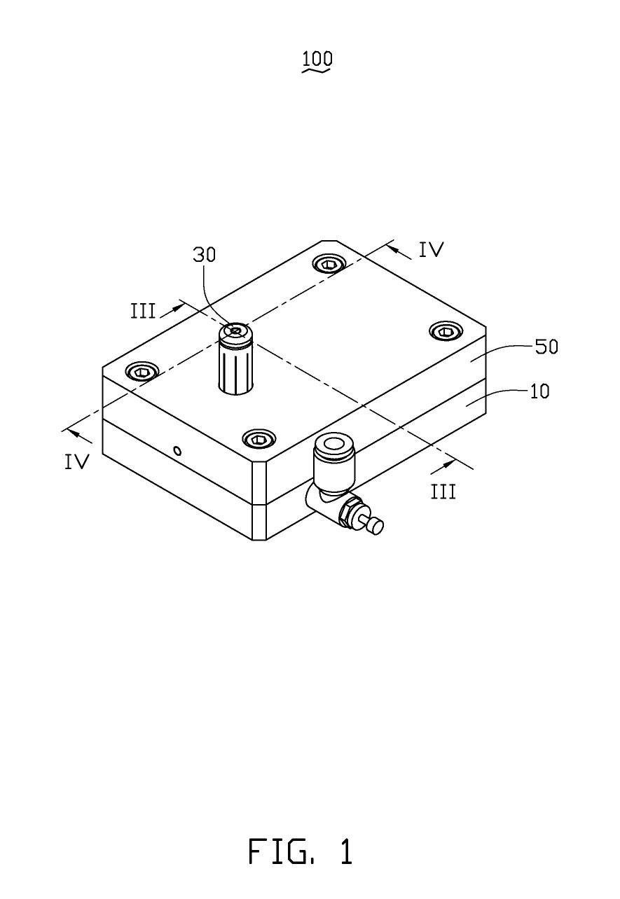

FIG. 1 illustrates an embodiment of a positioning mechanism 100 to position a workpiece (not shown) defining a positioning hole. The positioning mechanism 100 can include a base seat 10, an expansion assembly 30 mounted to the base seat 10, and a covering plate 50 sleeved on the expansion assembly 30 and secured to the base seat 10. An outer air source/hydraulic source can be adopted to provide power for the positioning mechanism 100. In the embodiment, the positioning mechanism 100 can adopt the outer air source to provide the power.

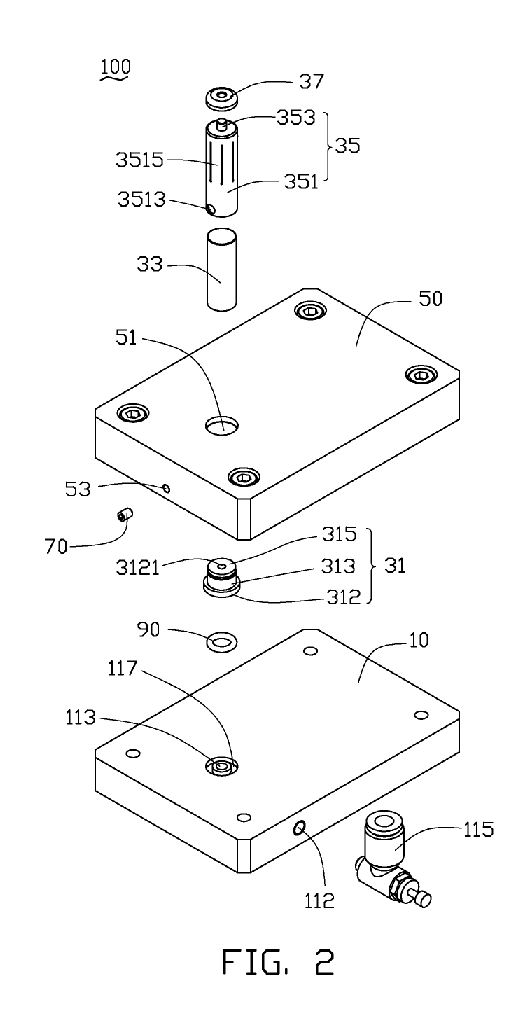

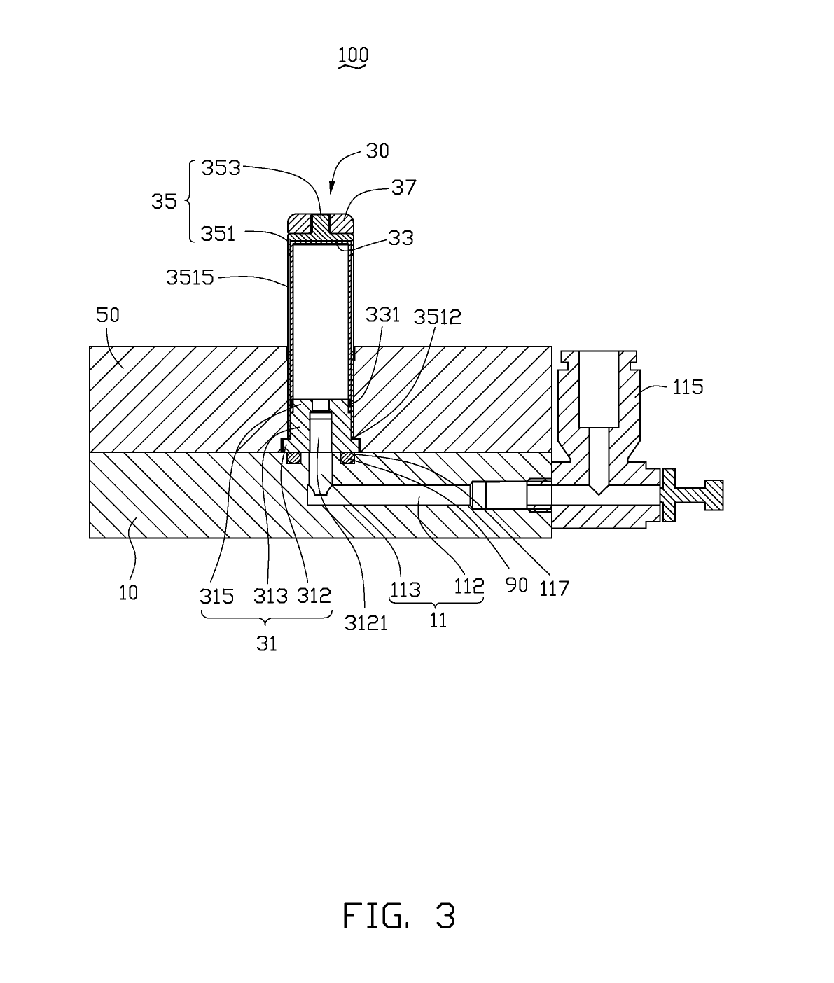

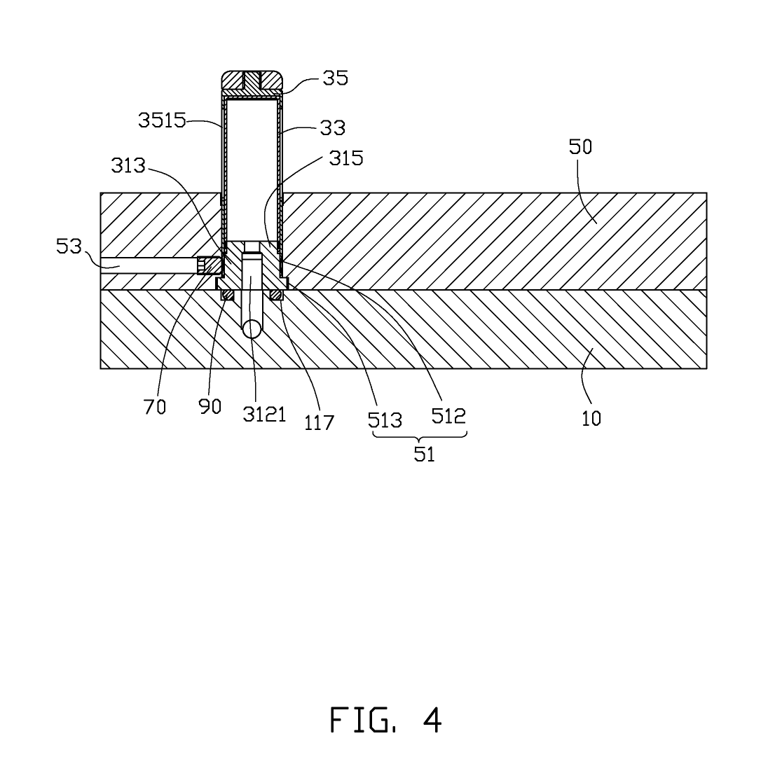

Referring to FIGS. 2 through 4 the base seat 10 can define a substantially L-shaped fluid conduit 11 therein. The fluid conduit 11 can include an entrance line 112 oriented along a longitudinal direction of the base seat 10, and a connecting line 113 substantially perpendicularly coupled to the entrance line 112. The connecting line 113 can open through a top of the base seat 10. A governor joint 115 can be coupled to the entrance line 112 and coupled to the outer air source to introduce airflow into the fluid conduit 11. The base seat 10 can further define an annular positioning groove 117, which can surround a periphery of an end of the connecting line 113.

The expansion assembly 30 can include a connecting plug 31, a deformable sealing sleeve 33, an expansion sleeve 35, and a protection block 37. The connecting plug 31 can be stepped-columnar shaped and coupled to the connecting line 113 of the base seat 10. The connecting plug 31 can include a resisting portion 312, a sleeving portion 313 coaxially protruding from one side of the resisting portion 312, and a sealing portion 315 coaxially protruding from a distal end of the sleeving portion 313. A diameter of the sleeving portion 313 is less than a diameter of the resisting portion 312, but greater than a diameter of the sealing portion 315. The connecting plug 31 can axially define a through hole 3121. The through hole 3121 is cooperatively defined by the resisting portion 312, the sleeving portion 313, and the sealing portion 315. The through hole 3121 can be aligned to an opening of the connecting line 113.

The deformable sealing sleeve 33 can be a substantially hollow cylinder and can define a sealing hole 331 in one end thereof. The deformable sealing sleeve 33 can be sleeved onto the sealing portion 315 of the connecting plug 31 via the sealing hole 331 to hermetically seal the deformable sealing sleeve 33. In the embodiment, the deformable sealing sleeve 33 can be made of soft materials, such as rubber. When the airflow from the fluid conduit 11 flows into the deformable sealing sleeve 33, the deformable sealing sleeve 33 can be expanded.

The expansion sleeve 35 can house the deformable sealing sleeve 33 and be sleeved on the sleeving portion 313 of the connecting plug 31. An outer periphery of the deformable sealing sleeve 33 can resist against an inner periphery of the expansion sleeve 35. The expansion sleeve 35 can include an expansion portion 351, and a fixing portion 353 protruding from an end of the expansion portion 351. The expansion portion 351 can be a substantially hollow cylinder and be sleeved on the deformable sealing sleeve 33 and the sleeving portion 313. The expansion portion 351 can define an opening 3512 in an end thereof away from the fixing portion 353, and a restricting hole 3513 in a periphery thereof. The restricting hole 3513 can be defined adjacent to the opening 3512. The expansion sleeve 35 can be sleeved on the sleeving portion 313 via the opening 3512. The periphery of the expansion portion 351 can define a plurality of slits (not labeled) oriented along a longitudinal direction of the expansion sleeve 35, thereby forming a plurality of resilient arms 3515. Each resilient arm 3515 is formed between two adjacent slits. Each resilient arm 3515 can expand radially outward from the expansion sleeve 35. In an embodiment, the expansion sleeve 35 can be made of metallic materials having high elasticity, such as spring steel. When the workpiece is sleeved on the expansion sleeve 35, the plurality of resilient arms 3515 can be expanded radially outward by expansion of the deformable sealing sleeve 33 received in the expansion sleeve 35, causing the plurality of resilient arms 3515 to resist against an inner periphery of the positioning hole of the workpiece. The fixing portion 353 can have a diameter less than a diameter of the expansion portion 351. The protection block 37 can be sleeved on the fixing portion 353 and resist an end portion of the expansion portion 351, to prevent the expansion sleeve 35 from damaging the workpiece when the expansion sleeve 35 expands. In the embodiment, the protection block 37 can be made of rubber.

The covering plate 50 can be sleeved on the expansion sleeve 35 and be secured to the base seat 10. The covering plate 50 can define a fixing hole 51 corresponding to the connecting line 113. The fixing hole 51 can be a stepped hole, which includes a receiving portion 512 and a latching portion 513. The expansion sleeve 35 can be partially received in the fixing hole 51 and partially extend out of the covering plate 50. The latching portion 513 can be adjacent to the connecting line 113 of the base seat 10. The resisting portion 312 of the connecting plug 31 can be received in the latching portion 513. The sleeving portion 313 and the sealing portion 315 of the connecting plug 31 can be received in the receiving portion 512. The covering plate 50 can further define an inserting hole 53 in a side thereof. The inserting hole 53 can extend to the fixing hole 51. The inserting hole 53 can be aligned to the restricting hole 3513 of the expansion sleeve 35.

In the embodiment, the positioning mechanism 100 can further include a jack screw 70 for positioning the expansion sleeve 35, and a sealing ring 90. An end of the jack screw 70 can be latched within the restricting hole 3513 of the expansion sleeve 35, and another end of the jack screw 70 can be received in the inserting hole 53 to prevent the jack screw 70 from detaching from the covering plate 50. The sealing ring 90 can be received in the positioning groove 117 to hermetically seal the covering plate 50 and the base seat 10.

In assembly, the sealing ring 90 can be received in the positioning groove 117 of the base seat 10. The connecting plug 31 can be received in the fixing hole 51, such that the resisting portion 312 is received in the latching portion 513, and the sleeving portion 313 and the sealing portion 315 are received in the receiving portion 512. The deformable sealing sleeve 33 can be sleeved on the sealing portion 315 of the connecting plug 31 via the sealing hole 331. The expansion sleeve 35 can be sleeved on the sleeving portion 313 of the connecting plug 31 via the opening 3512, and the inner periphery of the expansion sleeve 35 can contact the outer periphery of the deformable sealing sleeve 33 in an unexpanded state. The covering plate 50 can be secured to the base seat 10, and the expansion sleeve 35 can extend through the fixing hole 51 of the covering plate 50. The jack screw 70 can be received in the inserting hole 53 of the covering plate 50 and latch in the restricting hole 3513 of the expansion sleeve 35. The governor joint 115 can be coupled to the entrance line 112 of the base seat 10 and to the outer air source.

In use, the workpiece can be sleeved on the expansion sleeve 35 via the positioning hole. The airflow can be introduced into the fluid conduit 11 via the governor joint 115, and enter into the deformable sealing sleeve 33 via the through hole 3121. The deformable sealing sleeve 33 can be expanded by the airflow, thereby causing the plurality of resilient arms 3515 to expand outward to tightly resist the inner side of the positioning hole of the workpiece.

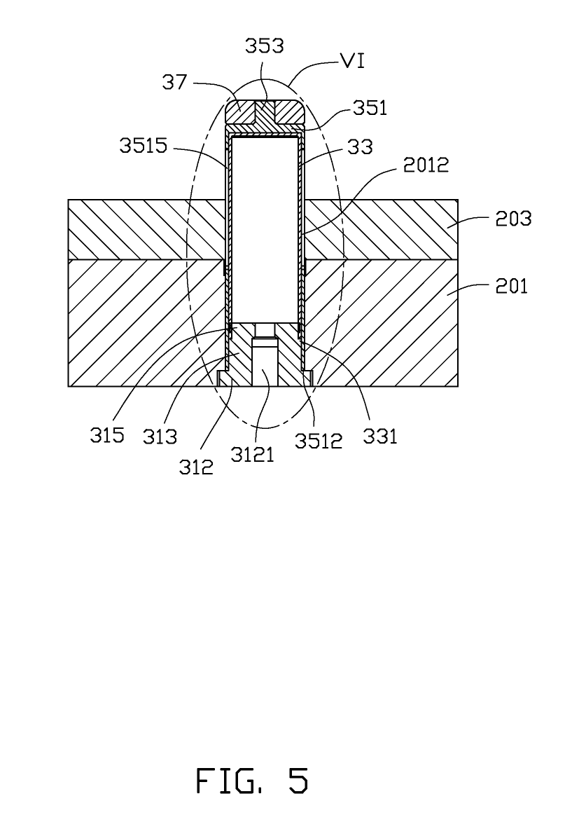

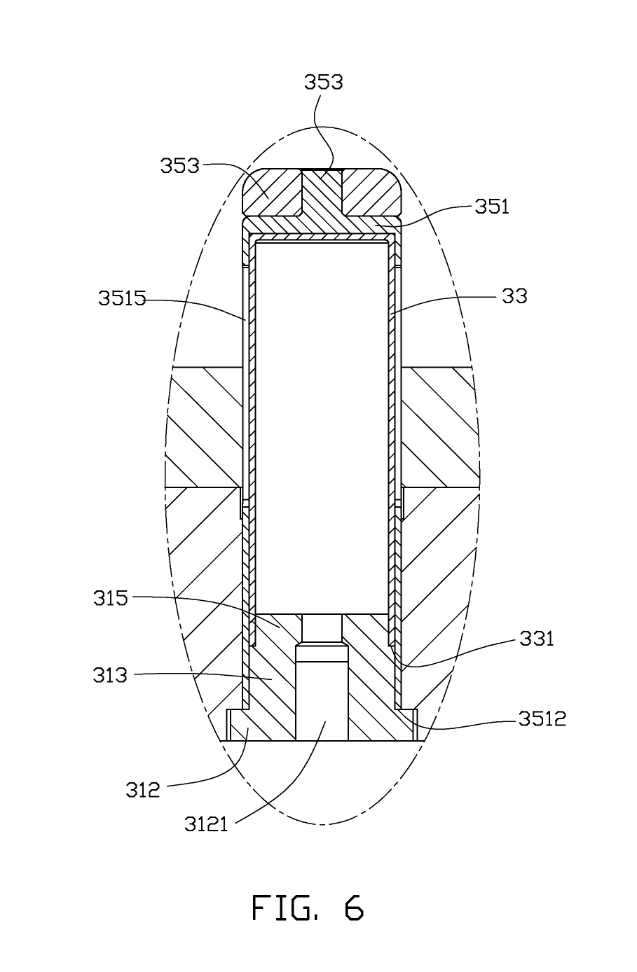

FIGS. 5 and 6 show the expansion assembly 30 used to position a first workpiece 201 and a second workpiece 203 together. The through hole 3121 of the connecting plug 31 can fluidly couple to the outer air source. In use, the expansion assembly 30 can extend through a positioning hole 2012 of the first workpiece 201 and the second workpiece 203. Airflow can flow into the deformable sealing sleeve 33. The deformable sealing sleeve 33 can be expanded by the airflow, thereby causing the plurality of resilient arms 3515 to expand outward to tightly resist the inner side of the positioning hole 2012 of the first workpiece 201 and the second workpiece 203. Thus, the first workpiece 201 and the second workpiece 203 are positioned together.

In other embodiments, the protection block 37 can be omitted. When the resisting portion 312 of the connecting plug 31 hermetically seals the base seat 10 and the covering plate 50, the sealing ring 90 can be omitted. When the expansion sleeve 35 is securely received in the covering plate 50, the jack screw 70 can be omitted.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. An expansion assembly, comprising:
a connecting plug defining a through hole configured for air flow to pass therethrough;
a deformable sealing sleeve sleeved on the connecting plug ; and
an expansion sleeve housing the deformable sealing sleeve and sleeved on the connecting plug;
wherein, the expansion sleeve comprises a plurality of resilient arms separated from each other, when air flow is introduced into the deformable sealing sleeve via the connecting plug, the deformable sealing sleeve expands to push against the plurality of resilient arms of the expansion sleeve, thereby bending the plurality of resilient arms outwardly.

2. The expansion assembly of claim 1, wherein the plurality of resilient arms is spaced from each other by a slit defined between every two adjacent resilient arms.

3. The expansion assembly of claim 1, wherein the connecting plug comprises a resisting portion, a sleeving portion protruding from a side of the resisting portion, and a sealing portion protruding from a side of the sleeving portion away from the resisting portion, the through hole opens through the resisting portion, the sleeving portion, and the sealing portion, the deformable sealing sleeve defines a sealing hole at an end and is sleeved on the sealing portion via the sealing hole, and the expansion sleeve defines an opening at an end and is sleeved on the sleeving portion.

4. The expansion assembly of claim 3, wherein the expansion sleeve comprises an expansion portion and a fixing portion protruding from an end of the expansion portion, the expansion portion houses the deformable sealing sleeve and is sleeved on the sleeving portion of the connecting plug, the expansion assembly further comprises a protection block sleeved on the fixing portion of the expansion sleeve, and the protection block resists an end of the expansion portion.

5. The expansion assembly of claim 4, wherein the deformable sealing sleeve is made of flexible material, and a periphery of the deformable sealing sleeve contacts with an inner side of the expansion portion.

6. A positioning mechanism, comprising:
a base seat defining a fluid conduit for air flow to pass therethrough;
an expansion assembly mounted on the base seat, the expansion assembly comprising:
a connecting plug defining a through hole for fluid to communicate with the fluid conduit;
a deformable sealing sleeve sleeved on the connecting plug ; and
an expansion sleeve housing the deformable sealing sleeve and sleeved on the connecting plug; and
a covering plate sleeved on the expansion sleeve and secured to the base seat;
wherein the expansion sleeve is partially exposed out of the covering plate and comprises a plurality of resilient arms, and the plurality of resilient arms is spaced from each other by a slit defined between every two adjacent resilient arms, when air flow in the fluid conduit is introduced into the deformable sealing sleeve via the connecting plug, the deformable sealing sleeve expands to push against the plurality of resilient arms of the expansion sleeve, thereby bending the plurality of resilient arms outwardly.

7. The positioning mechanism of claim 6, wherein the fluid conduit comprises an entrance line and a connecting line substantially perpendicularly coupled to the entrance line, the entrance line is configured for introducing the air flow into the connecting line, the covering plate defines a fixing hole corresponding to the connecting line, the connecting plug is received in the fixing hole, the through hole communicates with the connecting line, and the expansion sleeve is partially received in the fixing hole.

8. The positioning mechanism of claim 6, wherein the connecting plug comprises a resisting portion, a sleeving portion protruding from a side of the resisting portion, and a sealing portion protruding from a side of the sleeving portion away from the resisting portion, the through hole cuts through the resisting portion, the sleeving portion, and the sealing portion, the resisting portion resists the base seat, the deformable sealing sleeve is sleeved on the sealing portion, and the expansion sleeve is sleeved on the sleeving portion.

9. The positioning mechanism of claim 6, wherein the deformable sealing sleeve defines a sealing hole at an end and is sleeved on the sealing portion via the sealing hole, the expansion sleeve defines an opening at an end and is sleeved on the sleeving portion, the through hole of the connecting plug communicates with the sealing hole of the deformable sealing sleeve.

10. The positioning mechanism of claim 7, wherein the covering plate further defines an inserting hole coupled to the fixing hole, the expansion sleeve further defines a restricting hole at a side coupled to the opening, the positioning mechanism further comprises a jack screw, an end of the jack screw is received in the inserting hole, and an opposite end of the jack screw securely latches in the restricting hole.

11. The positioning mechanism of claim 7, wherein the base seat further defines a positioning groove surrounding an end of the connecting line, the positioning mechanism further comprises a sealing ring received in the positioning groove, and the sealing ring resists the connecting plug.

12. A positioning mechanism, comprising:
a base seat defining a fluid conduit;
an expansion assembly mounted on the base seat, the expansion assembly comprising:
a connecting plug defining a through hole communicating with the fluid conduit;
a hollow deformable sealing sleeve sleeved on the connecting plug; and
a hollow expansion sleeve receiving the deformable sealing sleeve and sleeved on the connecting plug; and
a covering plate sleeved on the expansion sleeve and secured to the base seat;
wherein the expansion sleeve comprises a plurality of resilient arms, and the plurality of resilient arms is partially exposed out of the covering plate and separated from each other, a periphery of the deformable sealing sleeve contacts with an inner surface of the expansion sleeve, when air flow in the fluid conduit is introduced into the deformable sealing sleeve via the connecting plug, the deformable sealing sleeve is expanded to push against the plurality of resilient arms of the expansion sleeve, thereby bending the plurality of resilient arms outwardly.

13. The positioning mechanism of claim 12, wherein the fluid conduit comprises an entrance line and a connecting line substantially perpendicularly coupled to the entrance line, the entrance line is configured for introducing the air flow into the connecting line, the covering plate defines a fixing hole corresponding to the connecting line, the connecting plug is received in the fixing hole, the through hole communicates with the connecting line, and the expansion sleeve is partially received in the fixing hole.

14. The positioning mechanism of claim 12, wherein the connecting plug comprises a resisting portion, a sleeving portion protruding from a side of the resisting portion, and a sealing portion protruding from a side of the sleeving portion away from the resisting portion, the through hole cuts through the resisting portion, the sleeving portion, and the sealing portion, the resisting portion resists the base seat, the deformable sealing sleeve is sleeved on the sealing portion, and the expansion sleeve is sleeved on the sleeving portion.

15. The positioning mechanism of claim 13, wherein the deformable sealing sleeve defines a sealing hole at an end and is sleeved on the sealing portion via the sealing hole, the expansion sleeve defines an opening at an end and is sleeved on the sleeving portion, and the through hole of the connecting plug communicates with the sealing hole of the deformable sealing sleeve.

16. The positioning mechanism of claim 15, wherein the covering plate further defines an inserting hole coupled to the fixing hole, the expansion sleeve further defines a restricting hole at a side coupled to the opening, the positioning mechanism further comprises a jack screw, an end of the jack screw is received in the inserting hole, and an opposite end of the jack screw securely latches in the restricting hole.

17. The positioning mechanism of claim 13, wherein the base seat further defines a positioning groove surrounding an end of the connecting line, the positioning mechanism further comprises a sealing ring received in the positioning groove, and the sealing ring resists the resisting portion of the connecting plug.
